(19) United States
(12) Patent Application Publication
(10) Pub. No.: US 2019/0304331 A1
(43) Pub. Date: Oct. 3, 2019

(54) ELECTRONIC BIOMETRIC MONITORING

(71) Applicant: Embry Tech, Inc., Newark, DE (US)

(72) Inventors: SARGIS KARAPETYAN, Askeran (AM); NARE GEVORGYAN, Yerevan (AM); TARON HOVHANNISYAN, Yerevan (AM); FELIKS KOCHARYAN, Yerevan (AM); HAMLET KARAPETYAN, Askeran (AM)

(73) Assignee: Embry Tech, Inc., Newark, DE (US)

(21) Appl. No.: 16/366,489

(22) Filed: Mar. 27, 2019

Related U.S. Application Data
(60) Provisional application No. 62/649,432, filed on Mar. 28, 2018.

(51) Int. Cl. G09B 19/00; G01G 19/44; G01G 19/52

(52) U.S. Cl. CPC G09B 19/00; G01G 19/52; G01G 19/44

(57) ABSTRACT

Techniques are described for calculating a new weight of a user for and/or detecting the activity, in which a user is engaged. In an embodiment, a biometric monitoring system receives an initial weight value that represents the initial weight of a user using the device for biometric monitoring. The device includes a weight sensor generates weight sensor data including weight force values representing the force applied by the user on the weight sensor during a time period. Based on the weight force values and the initial weight value, the system may calculate a new estimated weight of the user for the time-period or detect the activity that the user is engaged in the time period. In an embodiment, a biometric monitoring device includes a single weight sensor that has a surface area that is limited to only one of the following: heel area of a foot of the user, palm area of a foot of the user, or a toe of a foot of the user. In an embodiment, the weight sensor data is also used to detect a tilt in the placement of the users foot.

### BENEFIT CLAIM

This application claims the benefit under 35 U.S.C. § 119(e) of provisional application 62/649,432, filed Mar. 28, 2018, the entire contents of which is hereby incorporated by reference for all purposes as if fully set forth herein.

### FIELD OF THE TECHNOLOGY

The present invention relates to the field of electronic sensors, in particular to electronic biometric monitoring.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Accurate biometric measurement is important to help users, who spend a lot of time and money on weight management, to control their weight gain. Currently, to achieve accuracy in the biometric measurement requires many devices and software products (smartphone, smart scales, activity tracker) without much effect on the resulting weight gain.

Even if many biometric measurements are combined in one software platform, such platforms require multiple different hardware devices. For example, scales may be used to collect data such as body weight, body fat, and bone mass; and activity tracking devices may be used to collect data such as a number of steps, active and passive hours, sleep hours, some workouts statistics. Additionally, there is a wide variety of activity tracking devices, e.g., smart wristbands, smart watches, smartphones or other devices. When a single software platform collects data from two or three devices, the platform lacks correlation to calculate metrics such as burned calories, BMI to generate advice on nutrition and physical activity.

Further shortcomings of such platforms include lack of continuous data collection, the complexity of correlating data from multiple devices, requirements for manual user input, lack of clear representation of generated metrics. These shortcomings affect the usage of the platforms, for example, 1) users don't think there is a need to stand on scales if previous weight was in the healthy range, 2) users do not have time because of the tight schedule and enormous amount of information people acquire nowadays, 3) notifications are often mistimed and irrelevant because the platforms may not have continuous and real-time monitoring, 4) users give-up monitoring due to the presentation of raw unfavorable data (weight gain without any trend analysis or any message customization.

There is also a significant challenge to ensure that the tracking device is energy efficient but yet does not compromise the accuracy for the lower energy usage. Wearable tracking devices have limited energy storage as such devices are constrained with limited space suitable for wearing the device. To save energy, various power modes exist for the tracking device, most of them do so by limiting the length of tracking and thus, data collection performed. However, the lesser data yields less accurate monitoring causing the inaccuracies to be propagated to the user.

These and other technical shortcomings of the platform cause users to give up on wearing activity trackers because raw activity data provides no useful advice, or even if advice is provided based on a single tracking device, the advice would be inaccurate and incomplete rendering it useless.

### BRIEF DESCRIPTION OF THE DRAWINGS

In the drawings:

FIGS. 1A and 1B are block diagrams that depict a biometric monitoring system and its connectivity to user devices, in one or more embodiments.

FIG. 1C is a block diagram that depicts wearable device 100 integrated into shoe 108, in an embodiment.

FIG. 2A is a graph depicting initial weight data collected from a weight sensor as part of a calibration process, in an embodiment.

FIG. 2B is a graph depicting filtering anomalous weight force values from weight sensor data, in an embodiment.

FIG. 2C is a chart that depicts the acceleration applied to force-sensing module 260 of a wearable device, in an embodiment.

FIG. 3A is a flow diagram depicting a process for determining one or more biometric monitoring parameters, in one or more embodiments.

FIG. 3B is a flow diagram that depicts a process for determining the weight and/or difference in the weight of a user, regardless what activity the user is performing, in an embodiment.

FIG. 4 is a block diagram that illustrates a computer system 400 upon which an embodiment of the presented approach may be implemented.

### DETAILED DESCRIPTION

In the following description, for the purposes of explanation, numerous specific details are set forth in order to provide a thorough understanding of the presented approach. It will be apparent, however, that the presented approach may be practiced without these specific details. In other instances, well-known structures and devices are shown in block diagram form in order to avoid unnecessarily obscuring the presented approach.

### General Overview

Techniques are presented herein for a wearable device to accurately track various biometric measurements necessary for weight management, improving the energy consumption of the device. The user interface for the device provides accurate, relevant, personalized and timely advice.

In one embodiment, the wearable device is built-in into a shoe. In such an embodiment, the wearable device may be integrated into the shoe structure. Furthermore, the wearable device may use the existing components of a shoe, such as a shank, for tracking various biometric measurement. The re-use of the existing shoe components not only significantly reduces the cost of the built-in wearable device but saves greater space for an expanded energy storage device.

In another embodiment, the wearable device is a stand-alone device that is inserted into a shoe. The stand-alone device has an advantage over the built-in device because it is not specific to a shoe and can be interchangeable between different shoes, and thus does not require a user to obtain a specific shoe to track her activities.

In an embodiment, the wearable device includes a weight sensor to track the user's weight as well as the user's activity. The weight sensor may be a pressure sensor, a force sensor or a load sensor or any combination thereof.

To calculate the user's weight, multiple weight sensors may have to be necessarily used because the sensors have to cover the complete area of the downward force (weight force) on foot. However, there are two drawbacks to using multiple sensors: a) the multiple sensors increase the cost of the wearable device, b) the multiple sensors increase the footprint of the wearable device, and c) the multiple sensors use greater energy, which drains the limited energy store. To avoid these drawbacks, another technique may place sensors at a considerable distance from each other in order to compensate for the drawback. However, such an arrangement affects the accuracy of the weight calculation because the force has to be approximated across the area where no sensor is present, introducing a significant error.

To avoid covering the complete area under the foot with multiple sensors, techniques described herein may use an initial weight from an external source and use a single weight sensor to accurately calculate the difference of the weight of the user based on the force measurement of the single weight sensor. Thus, the techniques described herein considerably improve the technology by eliminating the need for having multiple weight sensors spread across the area under the foot. With a single weight sensor, there is no need to place weight sensors at a considerable distance from one another covering the full area of the sole for accurately and independently determining the weight of the user.

The “single weight sensor” term refers herein to an array of weight sensor modules concentrated within a limited contiguous portion of the foot area (e.g., under the heel or under the toe). In an embodiment, the array of weight sensor modules includes only a single sensor module. In another embodiment, the array of weight sensor modules includes a plurality of sensor modules. To calculate the force measurement of the single weight sensor, the measurements of the plurality of sensor modules are aggregated according to one or more statistical algorithms.

In an embodiment, the plurality of sensor modules of the single weight sensor includes at least one central sensor module and a plurality of edge sensor modules, each of which are located the closest to at least one point on the edge of the wearable device and between which the at least one central sensor module is located. Using the plurality of edge sensor modules, the wearable device may determine whether a particular reading of a central sensor module and thus the single weight sensor shall be disregarded. For example, if the difference between sensor force measurements of the plurality of edge sensor modules is greater than a threshold value, then a significant tilt exists during the landing of the foot. Therefore, the reading(s) of the single weight sensor is less accurate and may be disregarded for that landing. The “tilt” term refers herein to a deviation of the direction of the force from the z-axis (the axis perpendicular to the plain of the ground).

In an embodiment, the detection of tilt by the plurality of edge sensor may be reported for the detection of possible ailment in foot posture that can cause serious spine disease in the long term for the user.

The roll, pitch or yaw in the foot landing may be detected using an accelerometer. In an embodiment, in addition to a single weight sensor, the wearable device may include an accelerometer. The accelerometer may measure the acceleration of the foot in each direction. Since the device may detect the landing of the foot on the ground based on the peak in the force detected by the single weight sensor, the device may measure the acceleration in each axis using the accelerometer of the device for that point of time.

The “peak acceleration” term refers herein to a measurement of acceleration when the single weight sensor indicates that a peak force is applied to the sensor of the device. Based on one or more peak acceleration measurement, the weight sensor measurement may be further adjusted to increase the accuracy of the weight measurement. In such an embodiment, a lesser sample of the weight measurement may be collected to accurately represent an accurate change in the weight of the user, therefore requiring less operation of the single weight sensor and improving the energy consumption of the device.

Additionally or alternatively, the device may include a temperature sensor. Because a change in temperature may introduce an error in measurements of the single weight sensor, the measurements of temperatures from the temperature sensor are used to compensate for any error introduced due to the thermal conditions of the single weight sensor. A correction value is calculated based on the temperature sensor, based on which the force measurement of the single weight sensor is adjusted. Accordingly, the wearable device generates a more accurate force measurement that takes into account the thermal environment.

In an embodiment, the wearable device is coupled with an external computing device having a user interface for presenting information to target user-specific long-term weight loss and sustainment.

Additionally, a notifications system uses one or more communications channels to deliver messages (such as alarm, advice, warning) in a way that engages the user's social surrounding (friends, family, colleagues) to help the user. Thus, the notification system ensures not only that the user sees the message but will also take the actions.

### System Overview

A biometric monitoring system comprising software and hardware components to receive, process, calculate, track and store biometric data (for example bodyweight, different types of physical activities, burnt calories) based on weight sensor data received from biometric monitoring wearable device to be worn on at least one foot or leg of the user or be coupled to at least one foot or leg of the user. The “weight sensor data” refers herein to a set of measurements generated by a single weight sensor of a wearable device. The system also includes user interface and components configured for communicating with external computing devices of the user and other stakeholders in order to help the user set, reach and sustain healthy weight goals for the rest of the life.

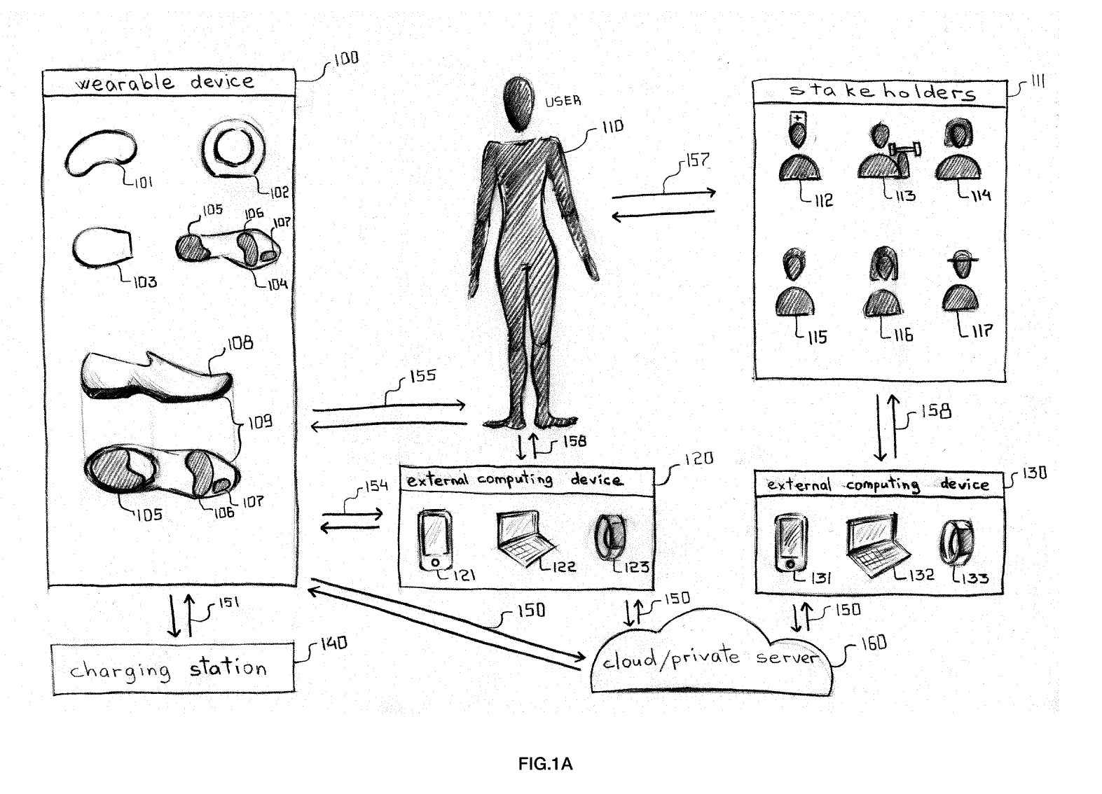

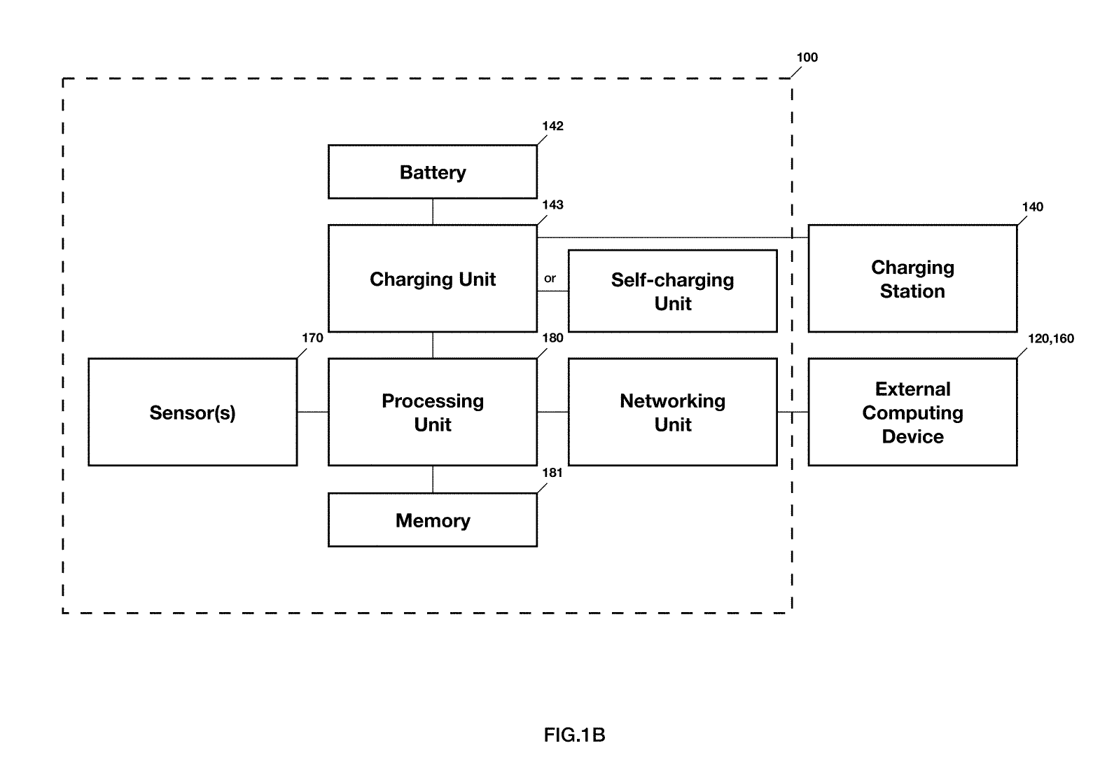

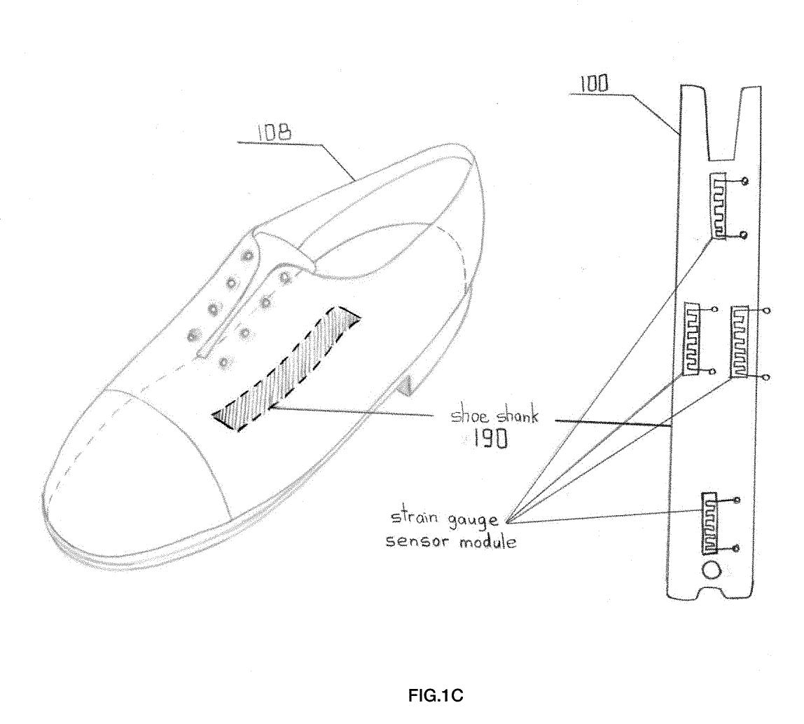

FIGS. 1A and 1B are block diagrams that depict a biometric monitoring system and its connectivity to external devices, in one or more embodiments. In different embodiments, wearable device 100 could have different physical shape and size. In one embodiment, wearable device 100 is pad 101 which could be attached to a foot of the user or inserted into any shoe under the foot. In another embodiment, wearable device 100 is shoe insert 103 to be attached to a foot of the user or inserted into any shoe under a heel of the user. In yet another embodiment, wearable device 100 is ring 102 which could be worn on one of the fingers of a foot (for example on the big toe). In yet another embodiment, wearable device 100 is insole 104 and with one or more of the weight sensors of wearable device 100 being located in one of the areas 105 (heel area), 106 (ball area), 107 (toe area) and may have the respective shape.

In yet another embodiment, wearable device 100 is integrated into shoe 108, for example, mounted in the sole 109 of the shoe 108 in one of the positions 105 (heel area), 106 (ball area), 107 (toe area) and may have the respective shape.

FIG. 1C is a block diagram that depicts wearable device 100 integrated into shoe 108, in an embodiment. Shoe 108 includes shank 190, which is used as a component of a single weight sensor of wearable device 100. Because shank 190 flexes under the force of the weight of user 110, the shank 190's measure of flexing corresponds to the force applied by user 110. By measuring the amount of the flex of shank 190, a measurement of force of the single weight sensor is collected.

In one embodiment, shoe shank itself may serve as a force-sensing resistance and thus, be the single weight sensor of wearable device 100. In another embodiment, one or more strain gauging sensor modules are attached to shoe shank 190 as part of the single weight sensor of wearable device 100. Multiple strain gauging sensor modules may be attached along a different axis of shoe shank 190, each detecting a force in a particular direction. Accordingly, the single weight sensor of wearable device 100 may detect roll, pitch or yaw based on the sensor module attached in the corresponding direction on shoe shank 190.

In an embodiment, the wearable device 100 comprises processing unit 180, sensor(s) 170, memory 191, networking unit 190, battery 142, charging unit 143. In one embodiment device includes self-charging unit 141, in another embodiment, device is connected to external charging station 140 with wire or wirelessly. The device is connected to external computing device 120,160.

The weight sensor data may be requested at a particular rate by the processing unit 180 and/or weight sensor data may be autonomously provided by the sensor(s) 170 at the particular rate to the processing unit 180.

The processing unit 180 further may store weight sensor data in memory 191 and/or send to external computing device 120,160, through networking unit 190 and/or process the weight sensor data then store in memory 191 and/or send to external computing device 120, 160 through networking unit 190.

In one embodiment, wearable device 100 comprises at least one weight sensor and no other type of sensors. In another embodiment, wearable device 100 comprises a single weight sensor and one or more of an acceleration sensor, gyroscope sensor, temperature sensor, humidity sensor and other sensors.

Different detection methods and units may be used for the single weight sensor (and for sensor modules thereof) such as capacitive unit in which weight sensor data is generated based on changes in capacitance, resistive unit in which weight sensor data is generated based on changes in electrical resistivity, piezoresistive unit in which weight sensor data is generated based on changes in electrical resistivity, optical unit in which weight sensor data is generated based on changes in properties of light, magnetic unit in which weight sensor data is generated based on changes in magnetic field, piezoelectric unit in which weight sensor data is generated based on changes in electrical potential, inductive unit in which weight sensor data is generated based on changes in inductance. The particular rate, at which the weight sensor data is requested or configured to be provided, may vary depending on the sensor unit type, for example the piezoelectric unit may have a higher frequency rate of weight sensor data generation and thus, the weight sensor data could be requested with higher frequency from the piezoelectric unit than piezoresistive unit.

In one embodiment, the external computing device 120, 160 is a mobile device 121, in other embodiment it is a laptop/computer 122, in another embodiment, such an external computing device is a smart wearable device 123 (for example smartwatch or smart wristband), in other embodiments, the external computing device is a cloud or private server 160.

The wearable device 100 may comprise lights, displays, vibration generators and speakers to communicate with the user 110. The wearable device may use audio/visual output when external device 120 is detected to be in the proximity. For example, when the external device is near to wearable device, the wearable device (and/or the external computing device 120) may detect through Bluetooth protocol-based discovery or GPS signal that user 110 is not wearing the device 100. Based on the detection, the biometric monitoring system may send a command to the wearable device 100 to output an audio and/or video signal (e.g., blink the lights or vibrate) automatically notifying user to wear the device.

In another embodiment, external computing devices (and their respective sensors) are used for further analysis of received weight sensor data such as to calculate corrections of inaccuracies in one or more biometric data metric. For example, the GPS data of the external computing device 120 may be used to minimize the inaccuracies in steps calculations during walking activity. Based on the distance determined by the GPS data, the calculated number of steps from weight sensor data may be adjusted upwardly or downwardly.

The biometric monitoring system further includes user interfaces to present the tracked weight sensor data, calculated and stored biometric data based on the weight sensor data. The biometric monitoring system may send textual/audio/video messages and/or notifications based on the biometric data. In one embodiment, such messages are scheduled to be sent automatically, or based on the progress (user configured thresholds triggered by the biometric data). In another embodiment, the messages and/or notifications may be sent to one or more stakeholders 111, then stockholders pass the message and/or notification to the user. Any type of communication channel 157 could be used between user 110 and stakeholders 111, for example, based on personal or over the wire communication between the external computing devices of stakeholders 111 and the biometric monitoring system. The biometric monitoring system may use the GPS signals of the user's external computing device 120 and stakeholder external device 130 to send the message and/or notification to one of the stakeholders nearest to the user's external computing device 120's location.

The stakeholder 111 is a human whom user chose to help him or to share data with or challenge and that human accepts that he/she agrees to be a stakeholder 111. In one embodiment the stakeholder 111 is a professional (for example doctor/dietitian/nutritionist) 112 or sports trainer 113, in another embodiment stakeholder 111 is a family member 114 (for example mother or brother), in another embodiment, stakeholder 111 is a colleague 115 or secretary 116 or just friend 117.

### Functional Overview

In an embodiment, the biometric monitoring system is provided with an initial accurate biometric data. The biometric monitoring system collects the weight sensor data from the wearable device. Based on the initial biometric data and the weight sensor data, current biometric data for the user of the wearable device is calculated and stored or presented to the user. Because the weight sensor data is updated and because the initial biometric data is provided, user's biometric data is calculated at any time using a single sensor without a need for a sensor array, in an embodiment.

In an embodiment, a sensor unit of the biometric monitoring system includes a single weight sensor. Initial biometric data provided to the biometric monitoring system is the initial weight of the user. The biometric monitoring system collects weight sensor data from the single weight sensor and using the initial biometric data calculates the current weight of the user.

In an embodiment, additional initial biometric data is collected by the biometric monitoring system by performing a calibration process.

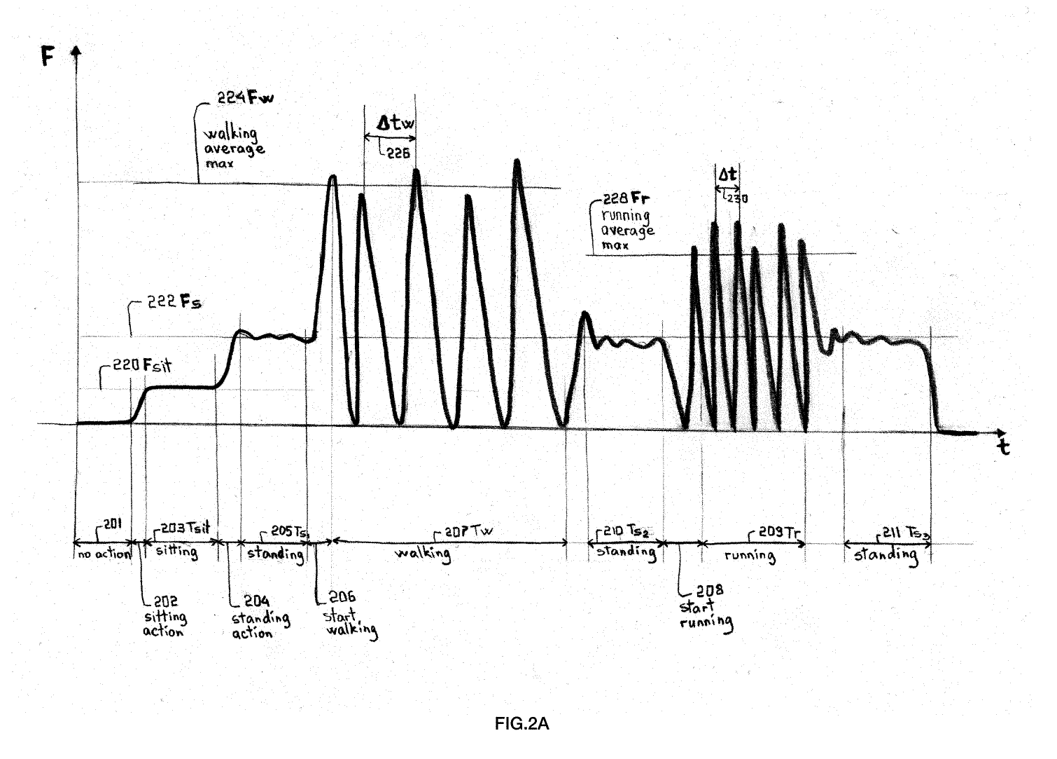

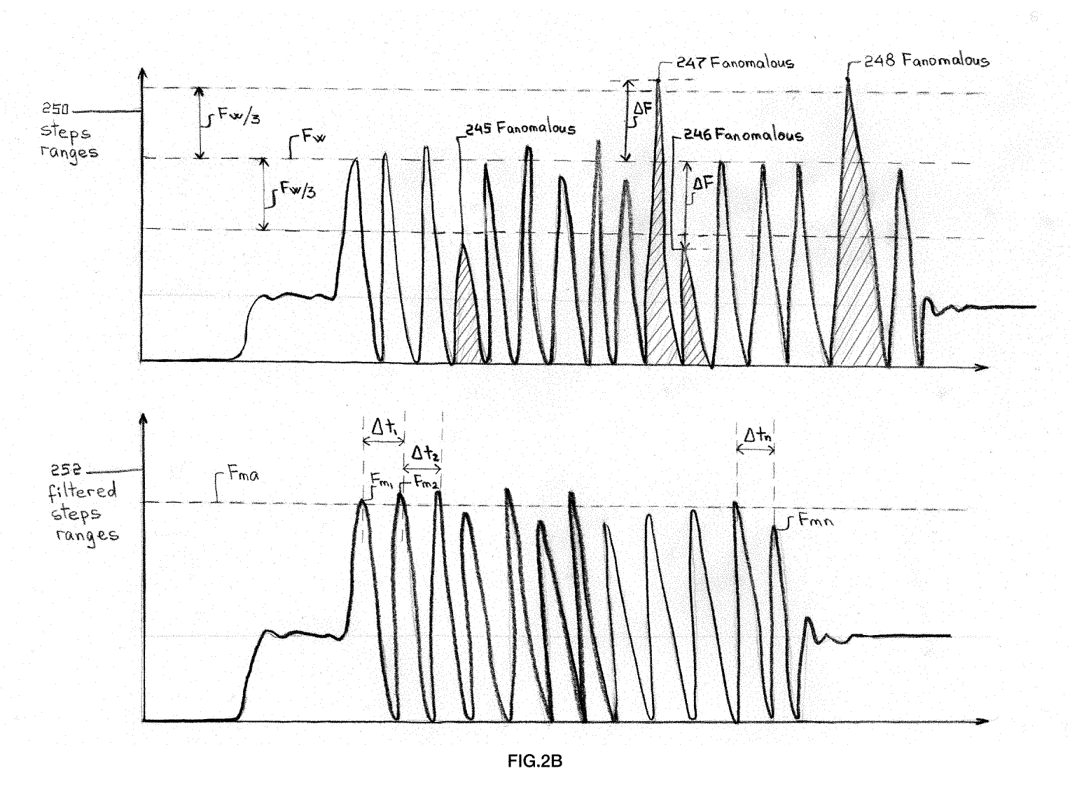

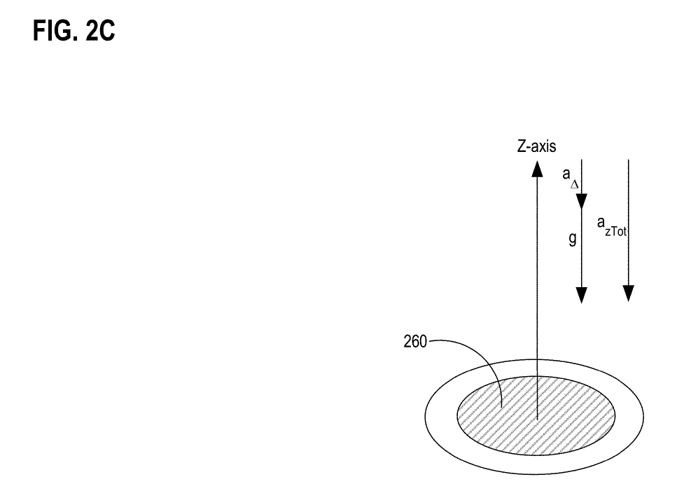

FIG. 2A is a graph depicting initial weight data collected from a single weight sensor as part of a calibration process, in an embodiment. During the system calibration process, the following parameters are determined and stored by the system, in one or more embodiments:

Pᵢ—the initial weight of the user inputted by the user.

Fₛᵢₜ 220—the aggregate maximum weight forces calculated based on weight sensor data from the single weight sensor during a limited time of sitting activity.

Fₛ 222—the aggregate maximum weight forces calculated based on weight sensor data from the single weight sensor during the limited time of standing activity.

F_{w} 224—the aggregate maximum weight forces calculated based on weight sensor data from the single weight sensor during the limited time of walking and/or the limited number of steps. In other embodiments, F_{w} may be determined based on any other statistical function or model.

Δt_{w} 226—the aggregate time period registered between two steps of the same foot to which the device is coupled during walking activity.

Fᵣ 228—the aggregate of maximum weight forces calculated based on weight sensor data from the single weight sensor during the limited time of running and/or the limited number of steps.

Δtᵣ 230—the aggregate time period registered between two steps of the same foot wearing the device during running activity.

In one or more embodiment, the aggregates described above are calculated based on statistical function(s) (e.g., average, median) or models (machine learning models).

Cₛ—the coefficient for a given user with a known Pi weight for standing

C_{w}—the coefficient for a given user with a known Pi weight for walking

Cᵣ—the coefficient for a given user with a known Pi weight for running

These coefficients may be determined heuristically. The coefficients may be calculated based on the sample weight force collected during the calibration and/or based on the initial weight of the user. For example, a coefficient for any activity may be determined by collecting the weight forces during the activity while in the calibration and dividing the initial weight of the user by the statistical function of the weight forces (such as the average or median weight), C=Pi/F (Cw=Pi/Fw). In another example, using the following equation P=(3*Pi−C*F)/2. The methodology of determining the coefficients may depend on the type of a sensor collecting weight sensor data and the housing of the sensor unit that absorbs the force. After the initial calibration, the system may be recalibrated automatically or initiated by the user.

In an embodiment, processing unit 180 or external computing device 160, 120 uses weight sensor data and applies the techniques discussed below to determine and track the biometric monitoring parameters such as the weight change of the user (ΔP), the extra carried weight (Pₑₓ), number of steps (Ns), walking time (T_{w}), running distance (Dᵣ), calories burnt (C_{b}) etc.

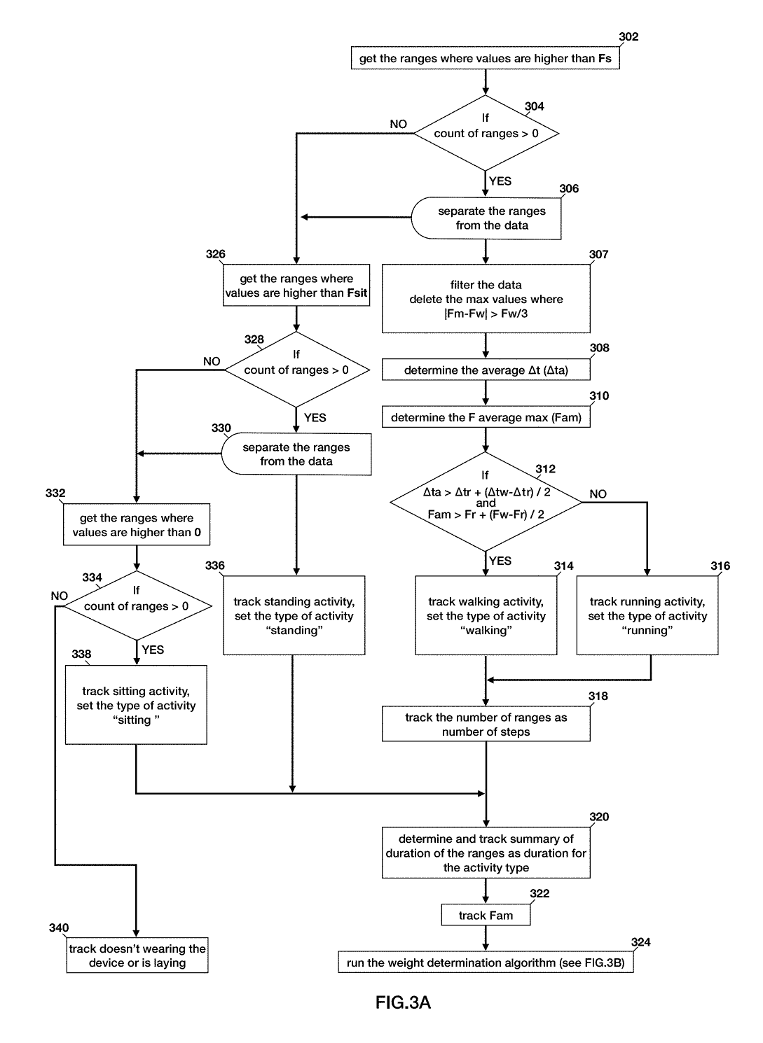

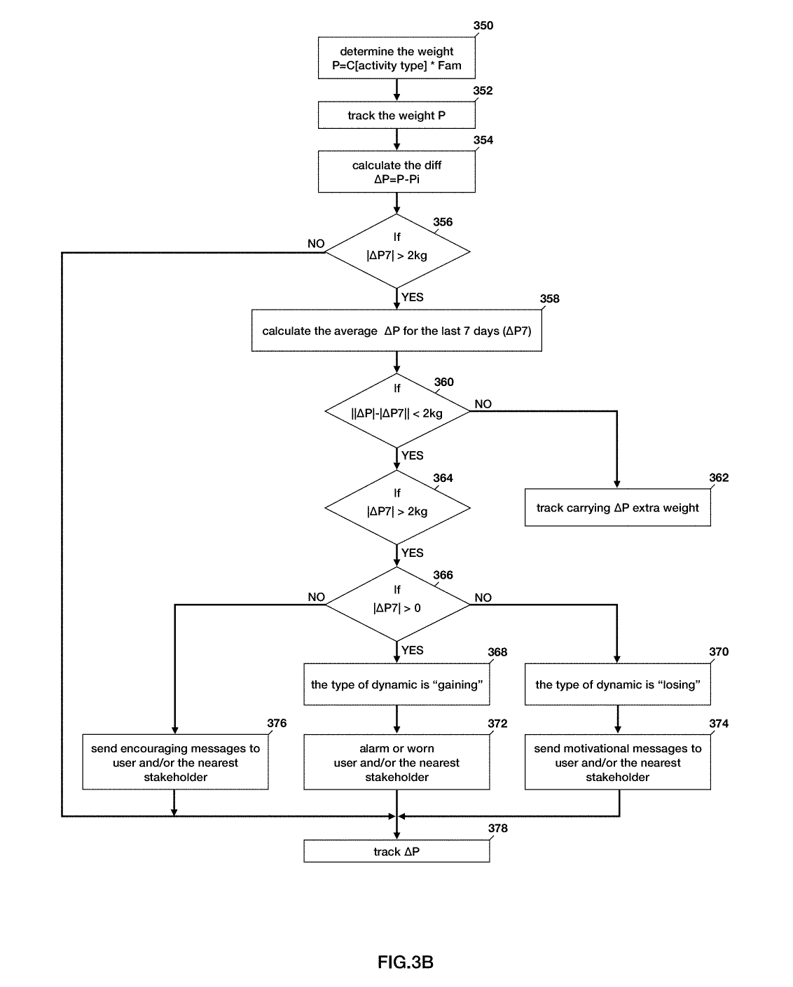

FIGS. 3A and 3B are flow diagrams depicting a process for determining one or more biometric monitoring parameters, in one or more embodiments. At step 302, a process reads weight sensor data and determines the set(s) of maximum weight force values of weight sensor data set (peaks of weight force recorded by the sensor(s)).

In an embodiment, where the maximum weight force value(s) is higher than the determined standing weight force, such as Fₛ 222 in FIG. 2A, the process proceeds to step 306 to evaluate whether the activity of the weight sensor data is “walking” or “running” and other information about the activity. At step 306, the process may split the weight sensor data such that the portion of the weight sensor data containing the selected maximum weight force values is processed in step 307 and onwards while the other portion of the weight sensor data is processed in step 326 and onwards.

### Filtering Anomalous Sensor Measurements

At step 307, the process filters the apportioned weight sensor data from anomalous values, in an embodiment. FIG. 2B is a graph depicting filtering anomalous weight force values from weight sensor data, in an embodiment. To determine anomalous weight force values, Fₐₙₒₘₐₗₒᵤₛ 245/246/247/248, all Fₘ maximum values, when full foot pressure is applied on the single weight sensor, is determined from the weight sensor data registered by the sensor(s).

In an embodiment in which the single weight sensor includes one or more central sensor modules and a plurality of edge sensor modules, if any of the edge sensor modules measurement is considerably higher than one or more other edge sensor modules, the readings for the corresponding maximum weight force are disregarded. Because the large difference in edge sensor module readings represents an occurrence of a significant tilt at foot landing, distorting the maximum weight force value reading. The large difference may be determined by comparing the difference to a threshold value, which may be determined heuristacally.

Additionally or alternatively, in an embodiment in which the wearable device includes an accelerometer, if significant acceleration (compared to gravitational acceleration) is detected in one or more direction at the point at which a maximum weight force is detected, the maximum weight force is disregarded. The detected acceleration significantly affects the accuracy of the measurement of the maximum weight force. In another embodiment, discussed further below, the detected acceleration is used to compensate the measured maximum weight force from the single weight sensor.

In an embodiment, maximum weight forces in a sample period are bucketized to determine whether a bucket of less frequent maximum weight forces exists. The range for each bucket may be pre-configured or may be based on a standard deviation of maximum weight forces. One or more buckets with the least number of maximum weight forces are disregarded as anomalous, Fₐₘ. The walking force, F_{w}, is determined based on the average of the remaining maximum force values.

In another embodiment, for each maximum weight force Fₘ, the difference is determined with the baseline maximum weight force (itself determined by average, median or any other statistical function applied on the maximum weight force values), ΔF=Fₘ−F_{w}. The biometric monitoring system may be configured to determine anomalous forces based on user configuration and/or sensor type. For example, the maximum weight force that is within a configured range of the baseline maximum weight force may not be designated as anomalous, e.g., ΔFₙₒᵣₘₐₗ=F_{w}/3. At the same time, if the maximum weight force is outside of the configured range, then the maximum |ΔF|>ΔFₙₒᵣₘₐₗ, and the maximum weight force corresponding to ΔF is an anomalous value. For example, the maximum weight forces 245 and 246 in FIG. 2B are less than F_{w} by F_{w}/3, thus are anomalous values and is discarded (or in another embodiment, assigned to F_{w}). Similarly, maximum weight force values 247 and 248 are greater than F_{w} by F_{w}/3, and therefore, are also designated as anomalous values.

### Adjustment Based on Supplemental Accelerometer Sensor Data

Maximum weight force values from weight sensor data may be adjusted by data from a supplemental sensor to increase the accuracy. In one embodiment, wearable device 100 contains an accelerometer measuring acceleration along one or more axis of the shoe in addition to a force-sensing sensor module. A force-sensing sensor module may produce an error for maximum weight force measurement when a user applies downward acceleration to its foot while a) walking: starting from the moment of its contact with ground till the moment of full placement of foot, and b) standing straight: both feet fully placed on the ground. An accelerometer measuring acceleration in the downward/upward direction (Z-axis) may be compared to the gravitational acceleration to determine the amount of correction to be applied to the maximum weight force measurement.

Because F_{z}_{_{\vec{T}ot}}=*a_{\vec{z}Tot}; where m is the mass of object, a_{zTot} is the peak measured acceleration along z-axis by the accelerometer, and F_{zTot} is the applied force along z-axis on the force-sensing module of the wearable device, the difference of the total measured acceleration with the gravitational acceleration over the peak acceleration is proportional to the error recorded in the force.

FIG. 2C is a chart that depicts the acceleration applied to force-sensing module 260 of a wearable device, in an embodiment. The accelerometer of the wearable device has measured a peak acceleration a_{zTot}, which has two components: gravitational acceleration g, and user applied acceleration, a_{Δ}. To determine the error caused by the user applied acceleration, a_{Δ}, The gravitational acceleration (g\vec{ }) is subtracted from the peak measured acceleration, a_{zTot}. The resulting user applied acceleration, a_{Δ}, represents the difference of peak measured acceleration with the acceleration that would have been measured if in steady state (motionlessly standing on the ground).

The raw reading from force-sensing sensor module 260 has also increased by the user applied acceleration. Therefore, the adjusted measurement value: S=S_{Tot}±ΔS; where S_{Tot} is the raw output value from force-sensing sensor module 260, and ΔS is the error caused by the user applied acceleration. The error in weight sensor data may be proportional to the actual sensor output value by as much as the user applied acceleration is to the peak acceleration.

ΔS\vec{ }=a_{\vec{Δ}}S_{\vec{T}ot}/a_{\vec{T}ot})=(a_{\vec{T}ot}−g\vec{ })*S_{\vec{T}ot}/a_{\vec{T}ot},

ΔS=|ΔS\vec{ }|.

For example, the force sensor measured value is 5000 and in the state of the z-axis acceleration value at the moment of foot landing has a peak acceleration of 1200 m/s². Thus, the following values are used to adjust the force sensor reading:

S_{Tot}=5000

|a_{\vec{T}ot}|=12 (m/s²)

|g\vec{ }|=9.8 (m/s²)

The corrected sensor value may be calculated by: ΔS=2.2*(5000/12)=916; S=5000−917=4084. Thus, the sensor value is adjusted to 4084.

Because the force-sensing sensor module values become more accurate using accelerometer data, less amount of weight sensor data is needed to produce an accurate measurement of change in the weight of the user. Accordingly, the sampling period for the single weight sensor may be reduced saving energy in the energy store.

### Adjustment Based on Supplemental Temperature Sensor Data

In an embodiment, a change in temperature affects the accuracy of a force-sensing module. Based on temperature sensor data, the weight sensor data is adjusted to take into account the error due to the temperature variation affecting one or more force-sensing sensor modules. For example, a load cell sensor module has both a particular operating temperature at which no error occurs and thermal sensitivity which increases based on the temperature difference from the particular operating temperature. A sample load cell sensor module may have temperature sensitivity of −0.05÷0.05 (% Span/° C.). Thus, the total error on sensor output (full span) may be as much as 0.1% per ° C. of temperature change in this example.

To adjust the force-sensing sensor module reading for a temperature-based error, temperature sensor data at the time of the reading is collected. Δt temperature change from the operating temperature for the sensor is multiplied by the error factor, such as 0.1% to get the percentage of error on the sensor's output. The final adjusted sensor output is based on the temperature change and the temperature-based error factor for the weight sensor, specifically the product of the two. Continuing with the example, the force-sensing module reading may be adjusted using the following formula:

S=S_{Tot}−((S_{Tot}*Δt*0.1%)/100%);

where S is the adjusted reading for sensor output, and S_{Tot}, is the raw/uncompensated sensor reading.

For example, if the raw/uncompensated value for the force-sensing module is 4084 and the temperature change is 5, then:

S_{Tot}=4084

Δt=5

S=4084−((4084*5*0.1%)/100%)=4063

Thus, the adjusted force-sensing sensor module reading is 4063 for this example.

Similar to the accelerometer-based adjustment, because the force-sensing sensor module values become more accurate using temperature sensor data, less amount of weight sensor data is needed to produce an accurate measurement of change in the weight of the user. Accordingly, the sampling period for the single weight sensor may be further reduced saving energy in the energy store.

### Determining Aggregate Weight Force

Continuing with FIG. 3A, at step 308, the process determines the Ata the average time period registered between two consequent steps, i.e., two adjacent maximum weight force values: Δta=(Δt1+Δt2+ . . . +Δtn)/n (See FIG. 2B).

At step 310, the process determines the aggregate weight force of maximum weight force values, Fₘ: Fₘ=(Fₘ₁+Fₘ₂+ . . . +Fₘₙ)/n (See FIG. 2B). In other embodiments, other statistical function maybe applied, such as a median, to calculate the aggregate weight force, Fₘ.

In an embodiment in which the single weight sensor includes one or more central sensor modules and a plurality of edge sensor modules, edge and central sensor module readings are separately averaged. The edge sensor modules measurements for a maximum weight force are averaged to generate average edge weight force and the central sensor module(s) measurement(s) for the maximum weight force are averaged to generate central edge weight force. The average edge weight force value is averaged with the average central weight force value to generate the average value of maximum weight force for the single weight sensor. In a different embodiment, the maximum weight force measurement is determined by averaging all the sensor module readings of the single weight sensor.

### Activity Monitoring

At step 312, the process compares Δta to a baseline time period to determine what type of activity caused the maximum weight force values. If the Δta is bigger than the half of the difference between calibrated Δt_{w} for walking and Δtᵣ for running (as described for FIG. 2A).

Based on step 312, the process determines that the activity type corresponding to the analyzed weight sensor data is “walking” and proceeds to step 314. Alternatively, the process determines based on step 312 that the activity type corresponding to the weight sensor data is “running” and proceeds to step 316.

Additionally or alternatively to step 312, the wearable device may include an accelerometer. The accelerometer data may be used to determine whether the activity is walking or running based on the accelerometer data. If the acceleration measurement is above a pre-configured threshold for running, then the system may determine that the user is running and proceed to step 316. If the acceleration measurement is above a pre-configured threshold for walking, then the system may determine that the user is walking and proceed to step 314. In an embodiment, the accelerometer measurement along only the x-axis (along the length of the shoe) is compared with the above thresholds.

At step 318, the process calculates the number of steps based on the number of maximum weight force values determined in the weight sensor data. Additionally, the process records the total amount of time spent on the current activity.

Returning to step 304, if the process determines that the weight sensor data contains maximum weight force values which are less than the determined standing weight force, e.g., Fs 222, then the process proceeds to step 326 to evaluate the weight sensor data and determine whether “sitting” or “standing” activity has occurred. At step 326, the weight force values that are higher than Fₛᵢₜ are selected, if any.

If at step 328, it is determined that there are weight force values that are above the Fₛᵢₜ, e.g., Fₛᵢₜ 220, then for the time period ranges corresponding to the selected weight sensor data at step 330, the activity type is designated as standing at step 336.

In an embodiment in which the single weight sensor includes one or more central sensor modules and a plurality of edge sensor modules, at step 336, the system further determines whether a tilt exists based on the difference in measurements from the plurality of edge sensor modules. The tilt may be detected on the side that is hosting the edge sensor module with the greatest measurement values compare to the other one or more edge sensors. In an embodiment, the tilt is reported to be detected when a difference between the greatest value and the smallest value of the plurality of edge sensors is above a pre-configured minimum. Based on the tilt detected during the standing activity a possibility of ailment in foot posture that can cause serious spine issues in the long term for the user may be reported.

Otherwise, if, at step 328, it is determined that there are weight force values that are not greater than Fₛᵢₜ, e.g. Fₛᵢₜ 220, the weight sensor data that contains weight force values that are greater than 0 is selected at step 332 (if any, based on the evaluation at step 334), and the time period corresponding to the selected weight sensor data is designated as a “sitting” activity. At step 338, any weight sensor data time period corresponding to no weight force value being detected is designated as the user is either not wearing the wearable device or has laid down.

Regardless of the designated activity type, the activity type, number of steps, if applicable, and/or the amount of time spent on the current activity is stored in the biometric monitoring system as the activity information for the weight sensor data at step 320. The maximum weight force values may also be recorded at step 322 and the weight of the use may be determined using the techniques described in FIG. 3B at step 324.

### Determining Weight

In an embodiment, the received weight sensor data is used to calculate continuous change in weight of the user. Based on the activity of the user (determined using techniques described above) and the maximum weight force value from the weight sensor data, the weight and/or the difference in weight may be determined.

FIG. 3B is a flow diagram that depicts a process for determining the weight and/or difference in the weight of a user, regardless what activity the user is performing, in an embodiment. At step 350, a process determines the user weight including extra carried weight based on the statistical function of weight force maximums. For example,

P=C[activity type]*Fₘ

(Ex. if activity type is “walking”, then the calibration factor C [activity type] is C_{w}).

At step 352, the process continuously reads weight sensor data and calculates weight P, thus tracking the user's weight. At any point in time, at step 354, the process calculates the difference between the initial input user bodyweight, Pi and currently calculated weight P: ΔP=P−Pi.

In an embodiment, inconsequential changes in weight are ignored. For example, at step 354, if the modulo of the ΔP is bigger than 2 kg (2 kg is the normal variation of the human weight during the day dependent on the time of the day and the inaccuracy of the scales), only then the process proceeds to determine the trend of the weight change.

At step 358, the process calculates the average ΔP for a preconfigured time period, for example, the last 7 days: ΔP7. At step 360, the process determines whether the change in the weight may be ignored due to being insignificant. For example, if the difference between the of ΔP and ΔP7 is smaller than 2 kg∥ΔP|−|ΔP7∥<2 then no action needs to be taken other than continuing to track the weight at step 362.

If, at step 360, it is determined that the difference between the weight change during the preconfigured time period and currently calculated weight is not significant, the process proceeds to step 376 and, at step 376, sends a motivational and encouraging to do something notification/message to a computing device of a user and/or a stakeholder who is the nearest by location to the user. Otherwise, if, at step 360, it is determined that the difference between the weight change during the preconfigured time period and currently calculated weight is significant, the process proceeds to step 364, in an embodiment. At step 364, the process may determine whether the preconfigured time period weight change is significant such as the ΔP for the last 7 days |ΔP7| is higher 2 kg. If so at step 366, if it is determined that the ΔP for the preconfigured time period, ΔP7, is greater than 0, then, at step 368, the type of the dynamics for weight change is “gaining” (determining that the user is gaining weight). At step 372, the process sends an alarm or warning notification to a computing device of a user and/or a stakeholder who is the nearest by location to the user.

Otherwise, at step 370, the process determines that the dynamics of weight change is “losing” (determining that the user is losing weight). At step 374, the process sends a motivational and congratulations notification/message to a computing device of a user and/or a stakeholder who is the nearest by location to the user.

In an embodiment, the system records the currently calculated weight difference ΔP at step 378 and may present based on the weight difference and historical changes in weight, historical weight values (and/or change of weight values) of the user on a user interface.

The process(es) described in FIGS. 3A and 3B may be performed on any computing device of a biometric monitoring system, including processing unit 180, external computing devices 120 or 160.

### Computer Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

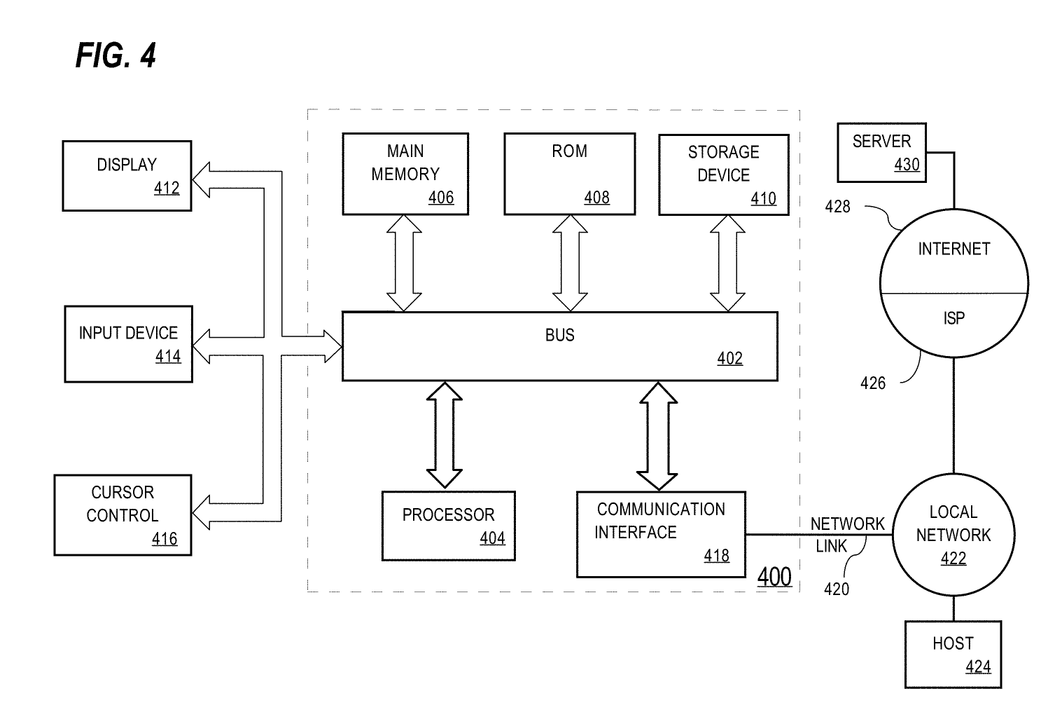

For example, FIG. 4 is a block diagram that illustrates a computer system 400 upon which an embodiment of the approach may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

Various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art will realize that embodiments of the disclosure may be practiced without the use of these specific details. In other instances, well-known structures and processes are not shown in block diagram form in order not to obscure the description of the disclosure with unnecessary detail. Thus, the present disclosure is not intended to be limited to the embodiments shown, but is to be accorded the widest scope consistent with the principles and features disclosed herein.

In the foregoing specification, embodiments of the presented approach have been described with reference to numerous specific details that may vary from implementation to implementation. The specification and drawings are, accordingly, to be regarded in an illustrative rather than a restrictive sense. The sole and exclusive indicator of the scope of the presented approach, and what is intended by the applicants to be the scope of the presented approach, is the literal and equivalent scope of the set of claims that issue from this application, in the specific form in which such claims issue, including any subsequent correction.

What is claimed is:

1. A computer-implemented method comprising:
receiving an initial weight value representing a weight of a user using a device that includes a weight sensor;
wherein the initial weight value is generated by an apparatus different from the device;
receiving weight sensor data from the weight sensor, weight sensor data comprising weight force values representing a force applied by the user on the weight sensor during a time-period;
based on the weight force values and the initial weight value, calculating estimated weight value for a new weight of the user for the time-period.

2. The method of claim 1, wherein the weight sensor is a single weight sensor.

3. The method of claim 1, further comprising:
determining a plurality of maximum weight force values from the weight force values, wherein each of the plurality of maximum weight force values is a peak value among one or more temporally contiguous weight force values of the weight force values;
aggregating the plurality of maximum weight force values using one or more statistical functions thereby generating an aggregate weight force value;
based on the aggregate weight force value, calculating the estimated weight value for the new weight of the user for the time-period.

4. The method of claim 1, further comprising:
determining a plurality of maximum weight force values from the weight force values, wherein each of the plurality of maximum weight force values is a peak value among one or more temporally contiguous weight force values of the weight force values;
aggregating the plurality of maximum weight force values using one or more statistical functions thereby generating an aggregate weight force value;
based on the aggregate weight force value, determining an activity type that the user is engaged in during the time period, which includes one or more of: walking, running, sitting and standing.

5. The method of claim 1, further comprising:
determining a plurality of maximum weight force values from the weight force values, wherein each of the plurality of maximum weight force values is a peak value among one or more temporally contiguous weight force values of the weight force values;
using one or more statistical functions, determining that one or more weight force values in the plurality of maximum weight force values are anomalous one or more weight force values;
using one or more statistical functions, aggregating the plurality of maximum weight force values that excludes the anomalous one or more weight force values thereby generating an aggregate weight force value;
based on the aggregate weight force value:
calculating the estimated weight value for the new weight of the user for the time-period, or
determining an activity type that the user is engaged in during the time period, which includes one or more of: walking, running, sitting and standing.

6. The method of claim 1,
wherein the weight sensor comprises a plurality of edge sensor modules, each of which are geometrically positioned to be the closest to at least one edge of the device among sensor modules of the weight sensor,
wherein the weight sensor data comprises a plurality of sets of edge sensor values, each set of the plurality of sets of edge sensor values originating from corresponding edge sensor module of the plurality of edge sensor modules, and
the method further comprising:
determining a plurality of sets of maximum edge weight force values from the plurality of sets of edge sensor values;
for each set of maximum edge weight force values of the plurality of sets of maximum edge weight force values, aggregating said set of maximum edge weight force values using one or more statistical functions into a corresponding aggregate edge weight force value thereby generating a plurality of aggregate edge weight force values;
based on the plurality of aggregate edge weight force values, calculating the estimated weight value for the new weight of the user for the time-period.

7. The method of claim 1,
wherein the weight sensor comprises at least one central sensor module and a plurality of edge sensor modules, each of which are geometrically positioned to be the closest to at least one edge of the device among sensor modules of the weight sensor,
wherein the weight sensor data comprises a plurality of central sensor values originating from the at least one central sensor module and a plurality of sets of edge sensor values, each set of the plurality of sets of edge sensor values originating from corresponding edge sensor module of the plurality of edge sensor modules, and
the method further comprising:
determining a plurality of maximum central weight force values from the plurality of central sensor values;
determining a plurality of sets of maximum edge weight force values from the plurality of sets of edge sensor values;
for each set of maximum edge weight force values of the plurality of sets of maximum edge weight force values, aggregating said set of maximum edge weight force values using one or more statistical functions into a corresponding aggregate edge weight force value thereby generating a plurality of aggregate edge weight force values;
based on the plurality of maximum central weight force values and the plurality of aggregate edge weight force values, calculating the estimated weight value for the new weight of the user for the time-period.

8. The method of claim 1, wherein
wherein the weight sensor comprises a plurality of edge sensor modules, each of which are geometrically positioned to be the closest to at least one edge of the device among sensor modules of the weight sensor;
the method further comprising:
determining a plurality of maximum weight force values from the weight force values, wherein each of the plurality of maximum weight force values is a peak value among one or more temporally contiguous weight force values of the weight force values;
comparing a first edge sensor value, from a first edge sensor module from the plurality of edge sensor modules, corresponding to at least one maximum weight force value from the plurality of maximum weight force values to a second edge sensor value, from a second edge sensor module from the plurality of edge sensor modules, corresponding to the same at least one maximum weight force value from the plurality of maximum weight force values;
based on the comparing the first edge sensor value to the second edge sensor value, determining that the at least one maximum weight force value is an anomalous weight force value;
using one or more statistical functions, aggregating the plurality of maximum weight force values that excludes the anomalous weight force value thereby generating an aggregate weight force value;
based on the aggregate weight force value:
calculating the estimated weight value for the new weight of the user for the time-period, or
determining an activity type that the user is engaged in during the time period, which includes one or more of: walking, running, sitting and standing.

9. The method of claim 1, further comprising:
determining a plurality of maximum weight force values from the weight force values, wherein each of the plurality of maximum weight force values is a peak value among one or more temporally contiguous weight force values of the weight force values;
receiving an accelerometer value from an accelerometer measuring acceleration of the device, wherein the accelerometer value temporally corresponds to at least one maximum weight force value of the plurality of maximum weight force values;
determining an acceleration error value based on comparing the accelerometer value to the gravitational acceleration;
adjusting the at least one maximum weight force value based on the acceleration error value thereby generating an adjusted weight force value;
aggregating the plurality of maximum weight force values, which includes the adjusted weight force value instead of the at least one maximum weight force value, using one or more statistical functions thereby generating an aggregate weight force value;
based on the aggregate weight force value, calculating the estimated weight value for the new weight of the user for the time-period.

10. The method of claim 1, further comprising:
determining a plurality of maximum weight force values from the weight force values, wherein each of the plurality of maximum weight force values is a peak value among one or more temporally contiguous weight force values of the weight force values;
receiving a temperature value from a temperature sensor measuring temperature of the device, wherein the temperature value temporally corresponds to at least one maximum weight force value of the plurality of maximum weight force values;
determining a weight force error value based on the temperature value and the at least one maximum weight force value;
adjusting the at least one maximum weight force value based on the weight force error value thereby generating an adjusted weight force value;
aggregating the plurality of maximum weight force values, which includes the adjusted weight force value instead of the at least one maximum weight force value, using one or more statistical functions thereby generating an aggregate weight force value;
based on the aggregate weight force value, calculating the estimated weight value for the new weight of the user for the time-period.

11. A device comprising:
a single weight sensor configured to generate weight sensor data comprising weight force values representing a force applied by a user on the single weight sensor during a time period;
wherein the device has a surface area that is limited to only one of the following: heel area of a foot of the user, palm area of a foot of the user, or a toe of a foot of the user.

12. The device of claim 11, wherein the device is a shoe insert.

13. The device of claim 11, wherein the device is a ring for a toe of the user.

14. The device of claim 11, wherein the single weight sensor comprises a plurality of weight sensor modules.

15. The device of claim 14, wherein the plurality of weight sensor modules comprises a plurality of edge sensor modules, each of which are geometrically positioned to be the closest to at least one edge of the device among sensor modules of the single weight sensor.

16. The device of claim 11, wherein the single weight sensor is a shank of a shoe that is worn by the user.

17. The device of claim 11, wherein the single weight sensor is mounted on a shank of a shoe that is worn by the user.

18. A computer-implemented method, comprising:
receiving weight sensor data from a weight sensor representing, at least in part, a weight of a user using a device that includes the weight sensor;
wherein the weight sensor data comprises weight force values representing the force applied by a foot of the user on the weight sensor during a time period;
based on the weight force values, detecting a tilt in a placement of the foot of the user.

19. The method of claim 18, wherein
wherein the weight sensor comprises a plurality of edge sensor modules, each of which are geometrically positioned to be the closest to at least one edge of the device among sensor modules of the weight sensor;
the method further comprising:
comparing a first edge sensor value, from a first edge sensor module from the plurality of edge sensor modules, to a second edge sensor value from a second edge sensor module from the plurality of edge sensor modules;
based on the comparing the first edge sensor value to the second edge sensor value, detecting the tilt in the placement of the foot of the user.

20. The method of claim 18, further comprising:
receiving an accelerometer value from an accelerometer measuring acceleration of the device, wherein the accelerometer value temporally corresponds to at least one maximum weight force value;
based on the accelerometer value, detecting the tilt in the placement of the foot of the user.
